(19) United States
(12) Patent Application Publication
(10) Pub. No.: US 2008/0158125 A1
(43) Pub. Date: Jul. 3, 2008

(54) Liquid crystal display device

(76) Inventors: Ikuko Mori, Chiba (JP); Kikuo Ono, Mobara (JP)

Correspondence Address: REED SMITH LLP, Suite 1400, 3110 Fairview Park Drive, Falls Church, VA, 22042, US

(21) Appl. No.: 12/003,441

(22) Filed: Dec. 26, 2007

(30) Foreign Application Priority Data
Dec. 28, 2006 (JP) 2006-354564

(51) Int. Cl. G09G 3/36

(52) U.S. Cl. 345/92

(57) ABSTRACT

In a driving method capable of dot inversion without an increase in power consumption of an IC, measures are taken to deal with the lack of time for wiring data signals, when the screen is enlarged and the number of pixels increases, or when the frame frequency increases. In order to obtain the same effect as the case of the dot inversion, the pixels are arranged in a staggered arrangement in which the polarity inversion of the data signal is performed with the same frequency as in the column-by-column inversion. In order to deal with the lack of time for writing data signals because of large screen or other reasons, preliminary writing is performed when the scan line of the previous row prior to the scan line in which the data signal is to be written is selected.

### CLAIM OF PRIORITY

The present application claims priority from Japanese Application JP 2006-354564 filed on Dec. 28, 2006, the content of which is hereby incorporated by reference into this application.

### BACKGROUND OF THE INVENTION

1. Field of the Invention

The present invention relates to a liquid crystal display device, and more particularly to a liquid crystal display device suitable for the display of a large screen with a high-speed refresh operation.

2. Description of the Related Art

The liquid crystal display device includes a large number of pixels formed in a matrix shape. Each of the pixels is surrounded by signal lines extending in a vertical direction and arranged in a horizontal direction as well as by scan lines extending in a horizontal direction and arranged in a vertical direction. When a scan line is selected by a scan driver, image data for one row is written from the data driver into pixels in the selected scan line at a time. In liquid crystal display devices for TV or other equipment having a screen increased in size, the number of scan lines increases because of large screen. Meanwhile, the period of time for one frame is fixed. Thus, the time for writing image data to pixels is reduced when the screen is enlarged, causing a phenomenon that the image reproduction is insufficient.

In order to deal with the case in which the writing time to pixels is insufficient, there is a method for compensating the lack of the writing time by performing preliminary writing in the previous scan of a selected scan line. Such a technology is disclosed in Japanese Unexamined Patent Application Publication No. 8-248385.

Further, in order to prevent the writing method from being affected by the scan of the previous scan line, there is a method for performing the preliminary writing five to four scans prior to the true scan, which is described in Japanese Unexamined Patent Application Publication No. 2004-301989.

Still further, in order to deal with the case in which the pixels are not sufficiently charged and flicker occurs in a high-speed refresh operation (switching the frame at a high frequency), there is a technology for changing the charge time depending on whether the polarity for charging the pixels is positive or negative, namely, a technology for changing the horizontal scan period, which is described in Japanese Unexamined Patent Application Publication No. 2002-108288.

When a direct current voltage is applied to the liquid crystal used for the liquid crystal display, electrolysis occurs, and the liquid crystal does not operate. For this reason, the liquid crystal display device is driven by an alternating current. There have been proposed various methods for driving the liquid crystal display by the alternating current. The methods can be roughly divided into the following three categories: frame inversion to reverse polarities on a frame by frame basis; line inversion to reverse polarities on a line by line basis; and dot inversion to reverse polarities on a dot by dot basis.

The simplest polarity inversion is the frame inversion. However, the flicker is likely to occur in the frame inversion. The line inversion includes a column-by-column inversion to reverse polarities for each column of a matrix, and a row-by-row inversion to revere polarities for each row of a matrix. In the both cases, lines are likely to be noticeable when the polarities are reversed. The dot inversion is least affected by the polarity inversion on the screen. However, in the dot inversion, the power consumption of the drive driver increases due to a high switching frequency, thus posing a problem of heat generation in the driver.

Further, when the screen is enlarged, the number of pixels increases and the frequency of the dot inversion increases, resulting in an increase of the heat generation. In other words, when the number of pixels increases because of large screen, there is a problem that the power consumption and the heat generation increase in the driver due to the dot inversion, in addition to the problem of insufficient time for writing image data to pixels. Further, in order to improve the motion picture characteristics of the liquid crystal device, there is a technology for generating an interpolation frame and a technology for inserting a black frame. However, the use of such technologies further increases the frame frequency, thereby worsening the problem of the lack of time for writing image data to pixels as well as the problem of heat generation in the driver in the case of the dot inversion.

### SUMMARY OF THE INVENTION

The present invention deals with the heat generation of the driver in the dot inversion driving as well as the lack of writing time to pixels, when the screen is enlarged, or when the interpolation frame or a black frame is inserted in order to improve the motion picture characteristics.

The present invention solves the above described problems. The specific measures are as follows:

(1) A liquid crystal display device includes pixels formed in a matrix shape. Each of the pixels is surrounded by signal lines extending in a vertical direction and arranged in a horizontal direction as well as by scan lines extending in the horizontal direction and arranged in the vertical direction, in which a pixel signal is supplied from the signal lines to the pixels by selection of a scan line. On one side of a specific signal line, a pixel corresponding to a specific color is connected to the specific signal line. On the other side of the specific signal line, a pixel corresponding to a different color is connected to the specific signal line. A specific pixel is connected to a specific scan line. When the specific scan line is selected and when a scan line that is two scans prior to the specific scan line is selected, the image signal is supplied to the specific pixel.

(2) In the liquid crystal display device described in (1), the polarities of the image signal supplied from the signal lines are opposite in adjacent lines.

(3) In the liquid crystal display device described in (1), the polarities of the image signal supplied from the signal lines are the same in one frame period, and are reversed when the frame is changed.

(4) A liquid crystal display device includes pixels formed in a matrix shape. Each of the pixels is surrounded by signal lines extending in a vertical direction and arranged in a horizontal direction as well as by scan lines extending in the horizontal direction and arranged in the vertical direction. On one side of a specific signal line, a pixel corresponding to a specific color is connected to the specific signal line. On the other side of the specific signal, a pixel corresponding to a different color is connected to the specific signal line. The pixel includes a pixel electrode and a TFT. The TFT has a gate connected to the scan line, a source connected to the signal line, and a drain connected to the pixel electrode. When a gate pulse is supplied to the scan line, a pixel signal is supplied from the signal line to the pixel. A TFT of a specific signal is connected to a specific scan line. When a gate pulse is supplied to the specific scan line and when a gate pulse is supplied to a scan line that is two scans prior to the specific scan line, the image signal is supplied to the specific pixel.

(5) In the liquid crystal display device described in (4), the gate pulse is supplied earlier than the start time of the image signal writing.

(6) In the liquid crystal display device described in (4), the gate pulse is supplied to the plural scan lines in series at a predetermined period. The width of the gate pulse is the same as the predetermined period.

(7) In the liquid crystal display device described in (4), the polarities of the image signal supplied from the signal lines are opposite in adjacent signal lines.

(8) In the liquid crystal display device described in (4), the polarities of the image signal supplied from the signal lines are the same in one frame period, and are reversed when the frame is changed.

(9) A liquid crystal display device includes pixels formed in a matrix shape. Each of the pixels is surrounded by signal lines extending in a vertical direction and arranged in a horizontal direction as well as by scan lines extending in the horizontal direction and arranged in the vertical direction. On one side of a specific signal line, a pixel corresponding to a specific color is connected to the specific signal line. On the other side of the specific signal line, a pixel corresponding to a different color is connected to the specific signal line. The pixel includes a pixel electrode and a TFT. The TFT has a gate connected to the scan line, a source connected to the signal line, and a drain connected to the pixel electrode. When a gate pulse is supplied to the scan line, a pixel signal is supplied from the signal line to the pixel. The gate pulse is supplied to the plural scan lines in series at a predetermined period. The width of the gate pulse is less than the predetermined period. A TFT of a specific pixel is connected to a specific scan line. When a gate pulse is supplied to the specific scan line and when a gate pulse is supplied to a scan line that is two scans prior to the specific scan line, the image signal is supplied to the specific pixel.

(10) In the liquid crystal display device described in (9), the gate pulse is supplied at the same time when the image signal writing is started.

(11) In the liquid crystal display device described in (9), the polarities of the image signal supplied from the signal lines are opposite in adjacent signal lines.

(12) In the liquid crystal display device described in (9), the polarities of the image signal supplied from the signal lines are the same in one frame period, and are reversed polarity when the frame is changed.

According to the measure (1), it is possible to obtain the effect of the gate double pulse even when the pixels are arranged in a so-called staggered arrangement. Thus, it is possible to reduce the non-writing voltage although the writing time of the image signal is insufficient because of large screen or other reasons.

According to the measure (2), when the pixels are arranged in the so-called staggered arrangement, it is possible to prevent flicker on the screen by performing the column-by-column inversion, and to reduce the non-writing voltage by the effect of the gate double pulse.

According to the measure (3), when the pixels are arranged in the so-called staggered arrangement, it is possible to obtain the effect of the dot inversion by performing the column-by-column inversion, and to reduce the non-writing voltage by the effect of the gate double pulse.

According to the measure (4), when the pixels, each having the TFT and the pixel electrode, are arranged in the so-called staggered arrangement, it is possible to obtain the effect of the gate double pulse, and to reduce the non-writing voltage although the writing time of the image signal is insufficient because of large screen or other reasons.

According to the measure (5), it is possible to close the gate pulse earlier than the completion of the image signal supply, by providing the gate pulse earlier than the timing of writing of the image signal. In this way, it is possible to prevent the image signal from being incorrectly written.

According to the measure (6), the period of the gate pulse is the same as the width of the gate pulse, so that it is possible to use a typical conventional IC for gate driving circuit.

According to the measure (7), when the pixels are arranged in the so-called staggered arrangement, it is possible to prevent flicker on the screen by performing the column-by-column inversion, and to reduce the non-writing voltage by the effect of the gate double pulse.

According to the measure (8), when the pixels are arranged in the so-called staggered arrangement, it is possible to obtain the effect of the dot inversion by performing the column-by-column inversion, and to reduce the non-writing voltage by the effect of the gate double pulse.

According to the measure (9), when the pixels, each having the TFT and the pixel electrode, are arranged in the so-called staggered arrangement, it is possible to obtain the effect of the gate double pulse, and to reduce the non-writing voltage although the writing time of the image signal is insufficient because of large screen or other reasons. Further, the width of the gate pulse is made smaller than the period of the gate pulse, so that it is possible to prevent the pixel voltage from decreasing during a period from the gate pulse rising edge to the image signal writing.

According to the measure (10), the timing of the gate pulse rising edge is the same as the timing of the image signal wiring, so that it is possible to prevent the pixel voltage from decreasing during a period from the gate pulse rising edge to the image signal writing.

According to the measure (11), when the pixels are arranged in the so-called staggered arrangement, it is possible to prevent flicker on the screen by performing the column-by-column inversion, and to reduce the non-writing voltage by the effect of the gate double pulse.

According to the measure (12), when the pixels are arrange in the so-called staggered arrangement, it is possible to obtain the effect of the dot inversion by performing the column-by-column inversion, and to reduce the non-writing voltage by the effect of the gate double pulse.

### BRIEF DESCRIPTION OF THE DRAWINGS

FIG. 1 shows an example of a method for driving a liquid crystal display device;

FIG. 2 shows an example of an aligned pixel arrangement;

FIG. 3 shows an example of a column-by-column inversion in the aligned pixel arrangement;

FIG. 4 shows an example of a dot inversion in the aligned pixel arrangement;

FIG. 5 shows an example of a staggered pixel arrangement;

FIG. 6 shows an example of a dot inversion in the staggered pixel arrangement;

FIGS. 7A, 7B show examples of a gray display driving in the aligned pixel arrangement;

FIGS. 8A, 8B show examples of a monochrome display driving in the aligned pixel arrangement;

FIGS. 9A, 9B show examples of a gray display driving in the staggered pixel arrangement;

FIGS. 10A, 10B show examples of a monochrome display driving in the staggered pixel arrangement;

FIGS. 11A, 11B show examples of a gray display driving in the staggered pixel arrangement, according to the present invention;

FIGS. 12A, 12B show examples of a monochrome display driving in the staggered pixel arrangement, according to the present invention;

FIG. 13 shows another example of the gray display driving in the staggered pixel arrangement, according to the present invention; and

FIG. 14 shows another example of the monochrome display driving in the staggered pixel arrangement, according to the present invention.

### DETAILED DESCRIPTION OF THE PREFERRED EMBODIMENTS

The present invention will be disclosed in detail according to the preferred embodiments.

### First Embodiment

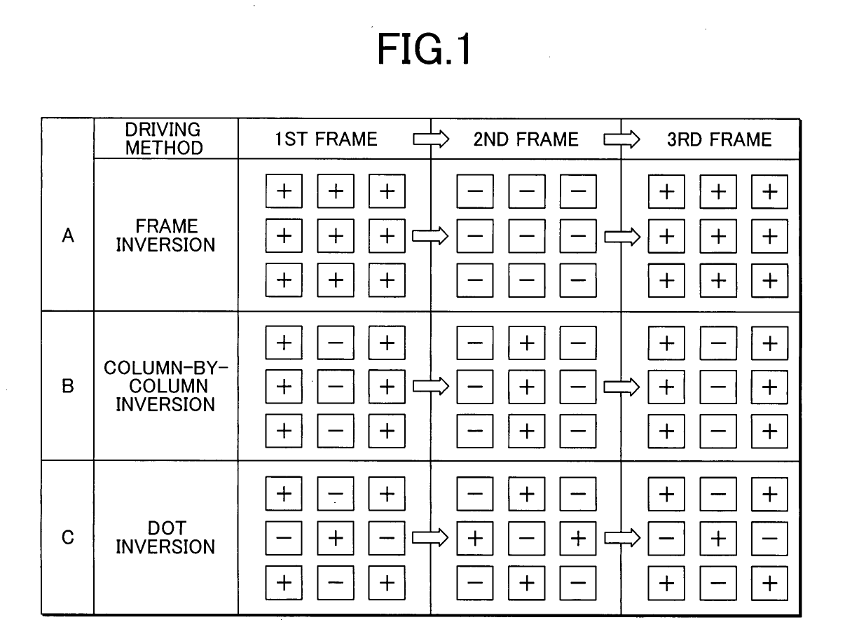

FIG. 1 shows various driving methods of polarity inversion. In FIG. 1, the squares with a sign represent pixels. Although a screen includes a large number of pixels, only nine pixels are described for the simplification of the figure. A in FIG. 1 is a driving method of frame inversion. In the first frame of the frame inversion in FIG. 1, all the pixels have positive polarity. This indicates that the signal voltages written into the pixel electrodes are all positive to the opposite electrode. In the second frame of A, all the pixels have negative polarity. This indicates that the signal voltages written into the image electrodes are all negative to the opposite electrode. The relationship in the third frame of A is the same as in the first frame of A. In the frame inversion, although the frequency for the signal polarity inversion is rather small, there is a risk that flicker may occur in each frame.

B in FIG. 1 is a driving method of column-by-column inversion. This driving method writes a signal of the same polarity to the common electrode in the same column. In other words, in B of FIG. 1, the positive and negative polarities are written alternately in each column, such that the image signal of positive polarity is written in the first column, the image signal of negative polarity is written in the second column, and the image signal of positive polarity is written in the third column. In the second frame, the polarity of each column is reversed in such a way that the image data of the first column has negative polarity, the image data of the second column has positive polarity, and the image data of the third column has negative polarity. In this case, the polarities of the image signal of the respective columns are not changed for one frame period, so that the heat generation of the driver is the same as that in the frame inversion. In the case of the column-by-column inversion, the flicker is reduced as compared to the frame inversion. However, there is a problem that vertical lines may be noticeable when the image signal is reversed.

C in FIG. 1 is a driving method of dot inversion. In the case of the dot inversion, an image signal of the polarity opposite to the polarity of a specific pixel is written into pixels located at the top, bottom, left, and right of the specific pixel. The polarity of the pixels is reversed when the frame is changed. The dot inversion has no problem such as flicker and vertical lines, providing an excellent image quality. However, since the dot inversion changes the polarity of the image data for each scan, the power consumption of the driver increases, and a problem of heat generation in the driver arises. Assuming that T represents the heat generation of the driver, T can be expressed as follows:

T=K·f·v²·c·n (1)

In the equation (1), K is the constant, f is the frequency for switching the polarity, v is the signal voltage, c is the capacity of the signal line, and n is the number of pins of the driver. In other words, the heat generation of the driver is proportional to the frequency for switching the polarity of the image signal. In the case of the column-by-column inversion in FIG. 1, the image data in each column holds the same polarity during one frame period, in which the frame frequency f is 60. In the case of the dot inversion in FIG. 1, the image data is switched for each scan line, in which f is equal to the product of the frame frequency and the number of scan lines. For example, the number of scan lines is 768 in WXGA display, so that the amount of heat generation of the driver in the case of the dot inversion is 768 times that in the case of the column-by-column inversion.

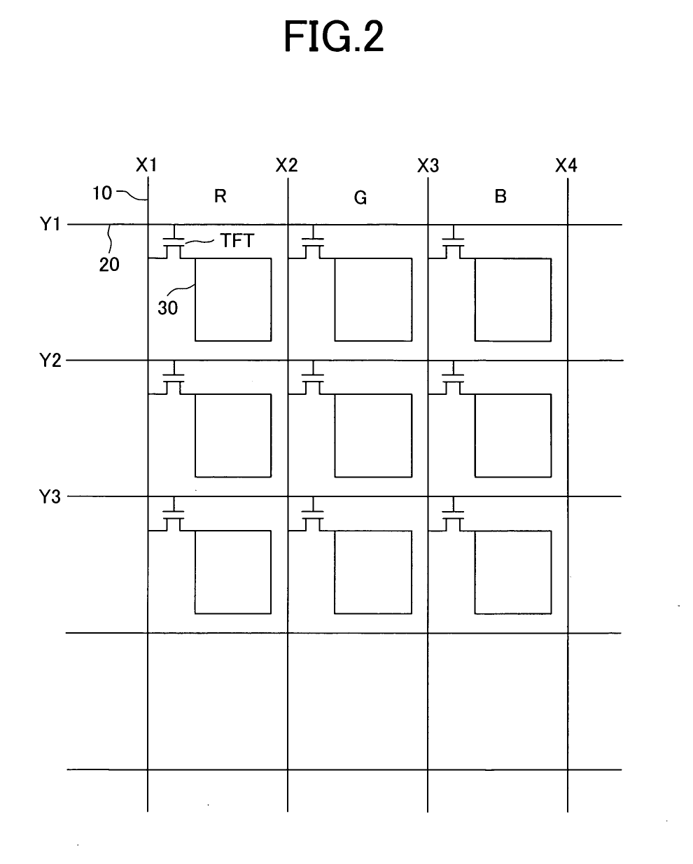

The present invention has a configuration to obtain the same effect as in the dot inversion, in the frequency of the column-by-column inversion, by employing the so-called staggered arrangement in place of the conventional method for supplying an image signal to each pixel. Referring to FIGS. 2 to 6, a description will be given of the comparison between the conventional pixel arrangement (hereinafter referred to as the aligned arrangement) and the staggered arrangement.

FIG. 2 shows an example of the aligned arrangement. Although the screen includes a large number of pixels, only nine pixels are described in FIG. 2. In FIG. 2, each pixel includes a pixel electrode 30 of an ITO, and a TFT for controlling a signal to the pixel electrode 30. The TFT has a gate connected to a scan line 20, a source electrode connected to a signal line 10, and a drain line connected to a pixel electrode 30. When a scan line Y1 is turned ON, an image signal is supplied from the signal lines 10 to the pixels existing in the first row. In FIG. 2, the image signal is supplied to the pixels in the same column from the same signal line 10. In FIG. 2, R represents the pixel displaying red, G represents the pixel displaying green, and B represents the pixel displaying blue, respectively.

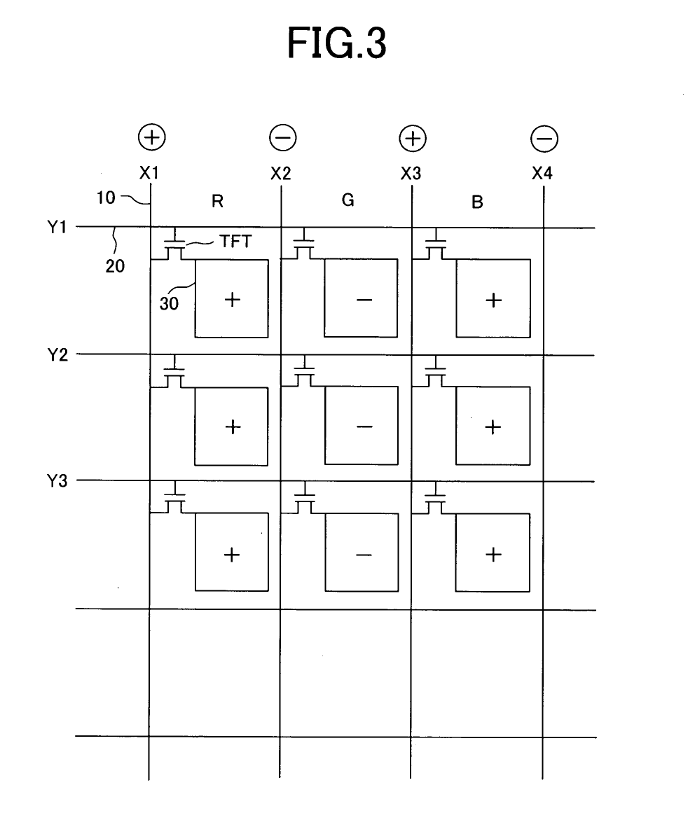

FIG. 3 shows an example of the column-by-column inversion in the aligned arrangement. In FIG. 3, the positive (+) or negative (−) sign is marked on image signal lines X1, X2, X3, and so on, which represents the polarity of the image data to be supplied to each of the signal lines. In this case, the polarity of the image data in each signal line is fixed for one frame.

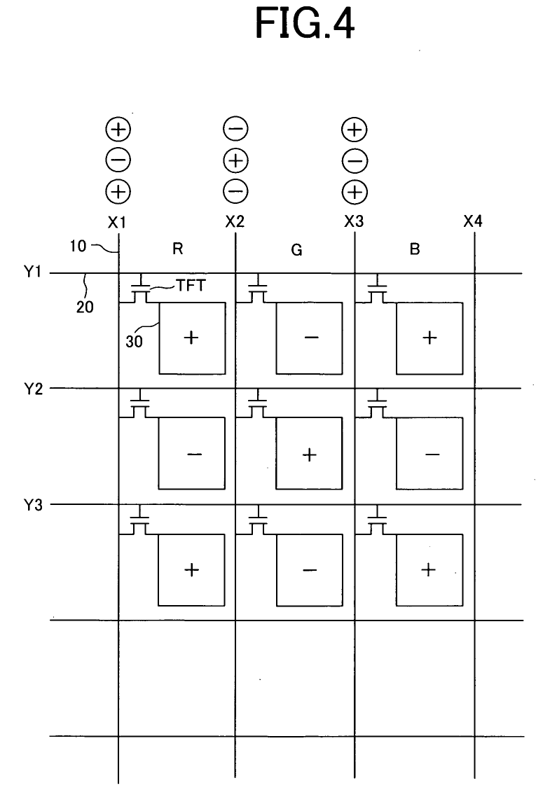

FIG. 4 shows an example of the dot inversion in the aligned arrangement. In FIG. 4, different from the case in FIG. 3, plural positive and negative signs are marked on each of the image signal lines X1, X2, X3, and so on. This means that the polarity of the image data is switched in the order of the scan lines 20. In other words, for the first scan line Y1, the polarities of the data lines X1, X2, X3 are +, −, + in this order. For the second scan line Y2, the polarities of the data lines X1, X2, X3 are −, +, − in this order. This is done by changing the data polarity in the driver. For this reason, the power consumption of the driver in FIG. 4 significantly increases as compared to the case in FIG. 3.

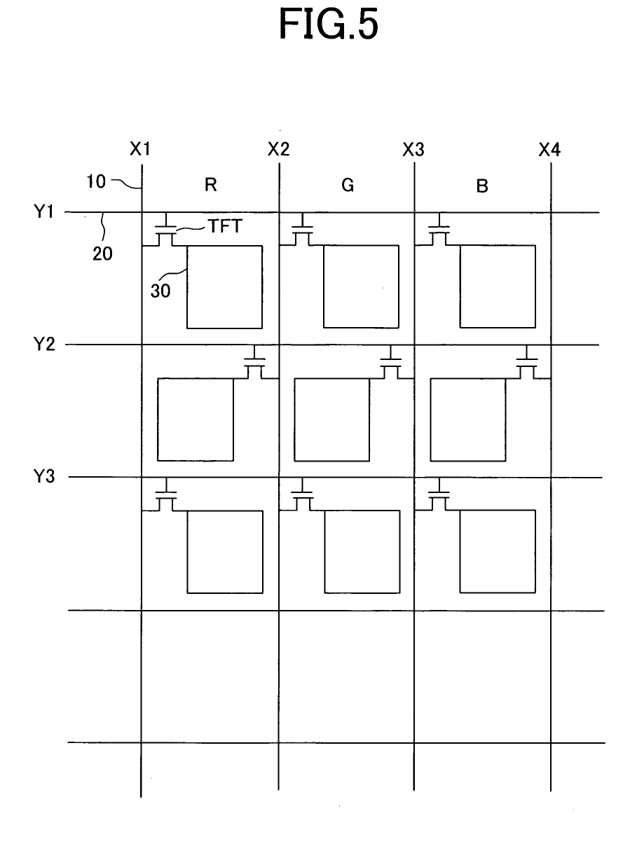

FIG. 5 shows a pixel arrangement in the case of the staggered arrangement. In FIG. 5, the image signal is supplied alternately from adjacent signal lines to the pixels in the same column. In other words, in relation to the pixels in the first row (R) in FIG. 5, the image signal is supplied to the pixel in the first scan line Y1 from the signal line X1, the pixel in the second scan line Y2 from the signal line X2, and the pixel in the third scan line Y3 from the signal line X1. In relation to the pixels in the second column (G), the image signal is supplied to the pixel in the first scan line Y1 from the signal line X2, the pixel in the second scan line Y2 from the signal line X1, and the pixel in the third scan line Y3 from the signal line X2. In this way, the data is supplied to the pixels alternately from the adjacent signal lines in the vertical direction.

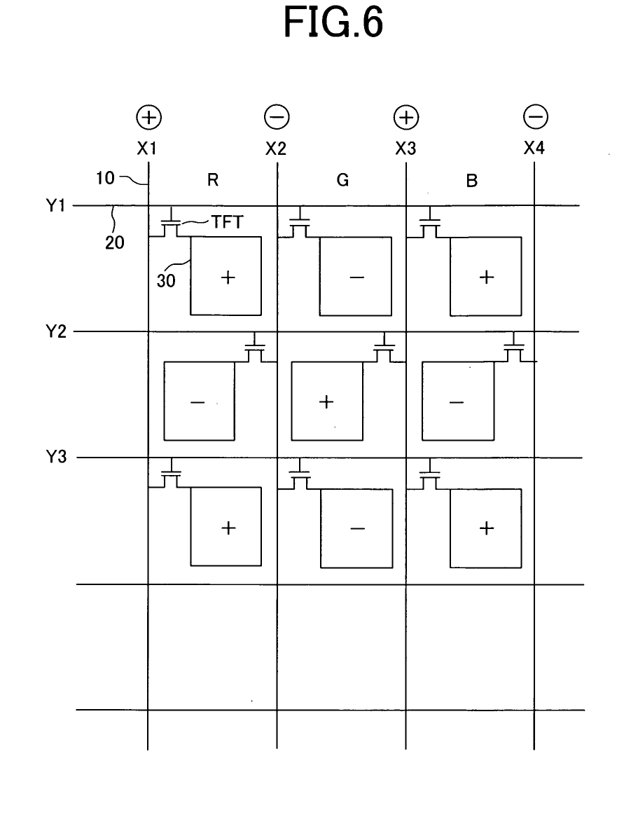

FIG. 6 shows a driving method in the case of the staggered arrangement. In FIG. 6, the positive (+) or negative (−) sign is marked on the image signal lines X1, X2, X3, and so on, which represents the polarity of the image data to be supplied to each of the signal lines. In FIG. 6, the signal polarity of each data line is fixed for one frame. However, the polarity of the signal is alternated in the same column. For example, in relation to the pixels in the first column, the pixel in the scan line Y1 has positive polarity, the pixel in the scan line Y2 has negative polarity, and the pixel in the scan line Y3 has positive polarity. In relation to the pixels in the second column, the pixel in the scan line Y1 has negative polarity, the pixel in the scan line Y2 has positive polarity, and the pixel in the scan line Y3 has negative polarity. Such signs are reversed when the frame is changed. In this way, the dot inversion is realized without changing the signal polarity of the signal line for each scan line. In other words, in the staggered arrangement, it is possible to realize the dot inversion with the same signal switching frequency as the frequency of the column-by-column inversion. As described above, the driving in the staggered arrangement has excellent features. However, different from the case of the aligned arrangement, it is necessary to pay particular attention to the signal writing by the double gate pulse, which will be described later.

The number of pixels increases when the screen is enlarged, so that the time for writing to the pixels is limited and the signal potential is not fully written into the pixels. Thus, a problem of a non-writing voltage arises. The problem of the non-writing voltage is worsened, when the frame frequency is increased by the high-speed refresh operation in order to improve the motion picture characteristics.

There is known a gate double pulse method as a method for preventing the generation of the non-writing voltage. This method writes, for example, data of the previous scan line before writing the original image signal by opening the gate of the TFT. The effect of the gate double pulse may be different depending on whether the data of the previous scan line is gray display data or monochrome display data. It is necessary to pay particular attention to the case of the staggered arrangement. Here, the gray display means that substantially the same image signal is written into pixels of three colors R, G, B. The monochrome display means that one of the three colors R, G, B is displayed.

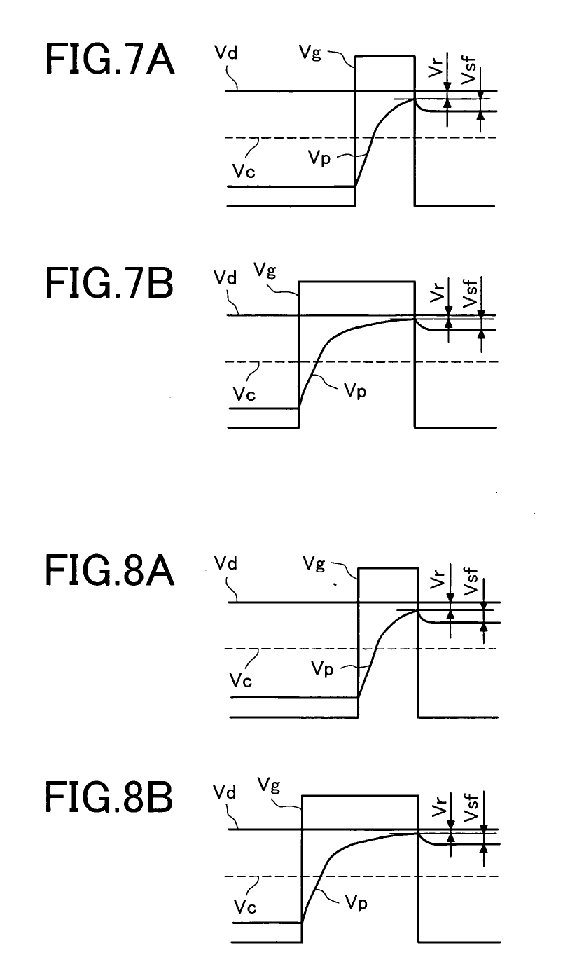

FIG. 7A shows a case in which a gray display is performed in a typical aligned arrangement by a typical single pulse, namely, in which the gate of a TFT in a pixel is opened only in a relevant scan line. In FIG. 7A, it is assumed that the signal potential is constant, and that the data of the relevant pixel and the data of the previous pixel have the same signal potential. When the scan line potential Vg is turned ON, the gate of the TFT is opened and the image signal is written into the pixel. Then, the pixel potential Vp increases. The pixel potential Vp is equivalent to the signal line potential Vd only when the time during which the gate is turned ON, namely, the writing time is sufficiently long. However, the figure shows that the writing time is insufficient and the non-writing voltage Vr1 remains. When the scan line potential Vg decreases and the gate is turned OFF, the pixel potential Vp is reduced by the V shift voltage Vsf. This is because the decrease of the gate voltage affects the pixel potential Vp through floating capacitance. In general, the center potential Vc is determined taking into account the V shift voltage Vsf.

FIG. 7B shows a case in which an image signal is written also in the row prior to the relevant pixel in order to deal with the non-written voltage Vr1 shown in FIG. 7A. Similarly to the case in FIG. 7A, the potential of the signal line in FIG. 7B is the same as the signal of the relevant pixel. In FIG. 7B, the gate of the TFT of the relevant pixel is open during the scan time for two scan lines. Thus, the writing time is sufficiently long and the pixel potential Vp changes as shown in FIG. 7B in which the non-writing voltage Vr1 is very small. Then, similarly to the case in FIG. 7A, when the scan line potential Vg decreases and the gate is turned OFF, the pixel potential Vp is reduced by the V shift voltage Vsf. In other words, this is the case in which the effect of the typical gate double pulse is fully demonstrated in the gray display in the aligned arrangement.

FIG. 8A shows an operation in which single pulse writing is performed in a monochrome display in the aligned arrangement. In the case of the aligned arrangement, the signal of the same color is also input into the pixel in the previous scan line. Thus, the operation in FIG. 8A is the very same as the operation in FIG. 7A. FIG. 8B shows an operation in which the gate double pulse is generated in the aligned arrangement. The operation in FIG. 8B is the same as the case of the gray display as described in FIG. 8A. In other words, the effect of the gate double pulse can be improved in both cases of the gray display and the monochrome display, as long as in the aligned arrangement.

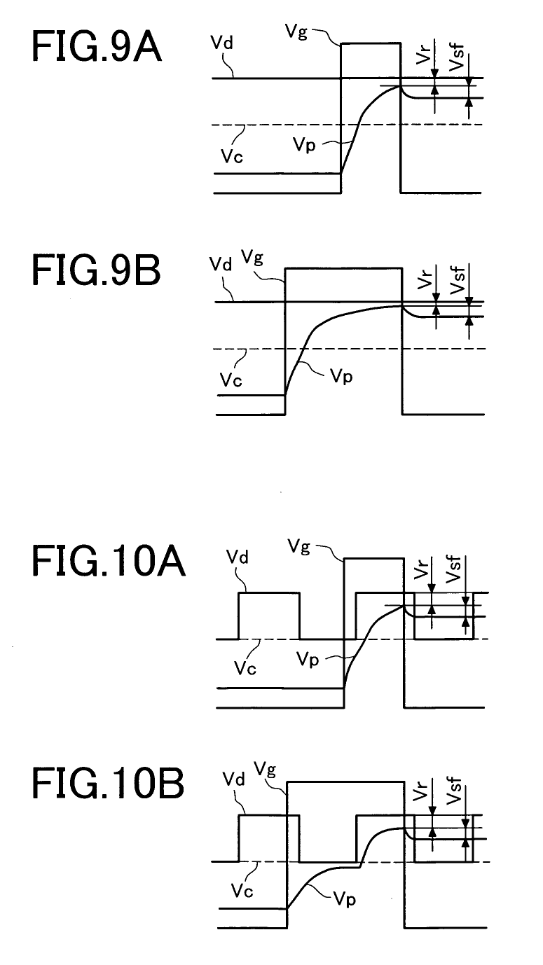

FIG. 9A shows a case in which writing is performed by the typical single pulse in the gray display in the staggered arrangement. The single pulse writing is not affected by the signal of the pixel prior to the relevant pixel, so that the writing operation of the image signal is the same as the case in the aligned arrangement.

However, in the case of the staggered arrangement, it is necessary to pay attention to the gate double pulse driving. In the case of the staggered display, the image signal to the pixel in the row prior to the relevant pixel is supplied from the adjacent signal line, and not from the same signal line as of the relevant pixel. Thus, the state of the gate double pulse driving in the staggered arrangement is different from the case in the aligned display. However, in the case of the gray display, the same image signal is input for each color, so that it is possible to assume that the same image signal as the image signal of the relevant pixel is input into the pixel prior to the relevant signal also in the staggered arrangement. Thus, the image signal writing is the same as in the case of the aligned arrangement in FIG. 7B. In other words, in the case of the gray display, the effect of the gate double pulse can be obtained also in the staggered arrangement, similarly to the case of the aligned arrangement. FIG. 9B shows such a state.

FIG. 10A shows a case in which the monochrome display is performed by the typical single pulse in the staggered arrangement. As described above, in the case of the staggered arrangement, the image signal to the pixel prior to the relevant pixel is supplied from the signal line of the adjacent pixel, and not from the signal line of the relevant pixel. In other words, the color of the image signal written into the pixel prior to the relevant pixel is not the same as of the relevant pixel, but is a different color. For example, when focusing on the G pixel in the scan line Y3 in FIG. 5, the image signal prior to the G pixel is the image signal of R.

In FIG. 10A, the signal line potential Vd is zero prior to the relevant pixel. This is because the monochrome display is performed. The signal line potential Vd of the previous pixel prior to the relevant pixel is the same as the signal line potential Vd of the relevant pixel. In FIG. 10A, the scan line potential Vg is high level, and then the image signal is supplied from the signal line. In this way, the image signal is written into the pixel. When the scan line potential Vg is high level, namely, when the gate of the TFT is opened, the pixel potential Vp increases although the signal line potential is zero. This is because the potential written into the pixel in the previous frame is a negative value, so that the pixel potential Vp increases only when the zero potential is written into the pixel from the signal line. Then, the pixel potential Vp continues to increase until the scan line potential Vg is low level and the gate of the TFT is closed. However, the pixel potential Vp does not reach a sufficient potential and the non-writing voltage Vr1 is generated. Then, the gate of the TFT is turned OFF, and the V shift occurs as described in FIG. 7A. The pixel voltage Vp is reduced by Vst and is maintained at this level.

FIG. 10B shows a case in which the monochrome display is performed by the gate double pulse in the staggered arrangement. As described in FIG. 10A, the color of the signal of the pixel prior to the relevant pixel in the same signal line is not the same as of the relevant pixel, but is a different color. Since FIG. 10B shows the case of the monochrome display, the signal prior to the relevant pixel is zero. In FIG. 10B, the gate of the relevant pixel is opened when the signal is written into the pixel prior to the relevant pixel. At this time, the signal line potential Vd is zero. However, the signal of the previous frame, which is negative, is written into the pixel, so that the pixel potential Vp increases although the signal line potential Vd is zero.

When the signal is written into the relevant pixel, the pixel potential Vp increases again to the signal line potential. However, the non-writing voltage Vr1 is generated due to insufficient writing time. Then, when the scan line potential Vg is low level and the gate of the TFT is closed, the V shift occurs. The pixel potential Vp is reduced by Vst and is maintained at this level. As apparent from FIG. 10B, the effect of the gate double pulse driving in the staggered arrangement is smaller than the other case.

According to the present invention based on the above knowledge, the gate pulse driving method in the staggered arrangement is designed to turn ON the gate of the TFT in the current row and in the previous row prior to the relevant pixel. In this way, it is possible to reduce the non-writing voltage in both cases of the gray display and the monochrome display.

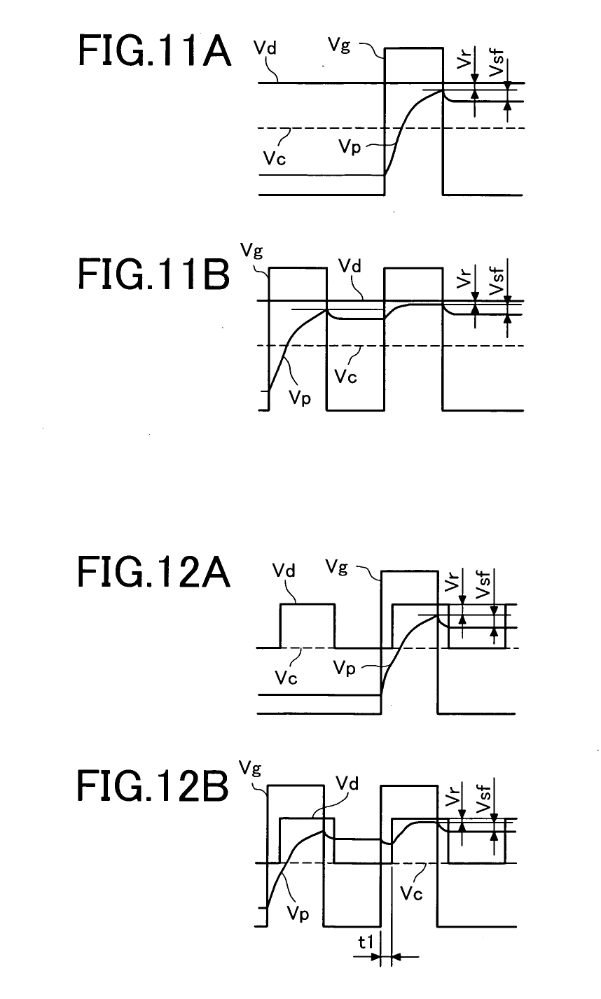

FIG. 11A shows a case in which the gray display is performed by the single pulse in the staggered arrangement. In this case, the operation is the same as described in FIG. 9A. FIG. 11B shows a case in which the gate double pulse is generated in the current row and the second previous row. In FIG. 11B, when the gate of the TFT is turned ON by the scan line of the second previous row, the pixel potential Vp increases. The scan line potential Vg of the second previous row is low level with a certain non-writing voltage Vr1 remaining, and the gate of the TFT is turned OFF. Then, the pixel potential Vp is reduced by the V shift voltage Vsf and is maintained at this level. Then, when the scan line potential Vg of the current row is high level, the gate of the TFT of the relevant pixel is opened again, the signal potential is written, and the pixel potential Vp increases. In this case, the pixel potential Vp has already approached the signal line potential Vd when the gate of the current row is opened, so that the non-writing potential is small. Thus, the effect of the gate double pulse can be fully demonstrated.

FIG. 12A shows a case in which the monochrome display is performed by the single pulse in the staggered arrangement. In this case, the operation is the same as described in FIG. 10A, and its description will be omitted. FIG. 12B shows a case in which the monochrome display is performed in the staggered arrangement by opening the gate TFT by the scan line potentials Vg in the current row and in the second previous row. In FIG. 12B, when the scan line potential Vg of the second previous row is high level, the gate of the TFT of the relevant pixel is opened. Then the pixel potential Vp increases. In this case, the increase of the pixel potential is the same as described in FIG. 10A. Here, a substantial amount of the non-writing voltage Vr1 remains. Then, when the gate is closed, the pixel potential Vp is reduced by the V shift voltage Vsf and is maintained at this level.

When the scan line of the current row is high level, the gate of the TFT of the relevant pixel is opened, and the pixel potential Vp increases again to the signal line potential Vd. In this case, at the time when the scan line potential Vg of the current row is high level and the writing is started, the pixel potential Vp has already increased by the writing in the second previous row. Thus, it is possible to significantly reduce the non-writing voltage Vr1, even if the time during which the gate of the TFT is opened by the scan line of the current row is not sufficient. As described above, according to the present invention, the effect of the gate double pulse can be fully demonstrated also in the case of the staggered arrangement.

### Second Embodiment

In FIG. 12B of the first embodiment, the pixel potential Vp slightly decreases during the time t1 in which the gate of the TFT is opened by the scan line potential Vg of the current row and then the signal potential is written. This is because the pixel potential Vp changes to the zero potential during t1. The decrease of the pixel potential Vp is a factor of the increase of the non-writing voltage.

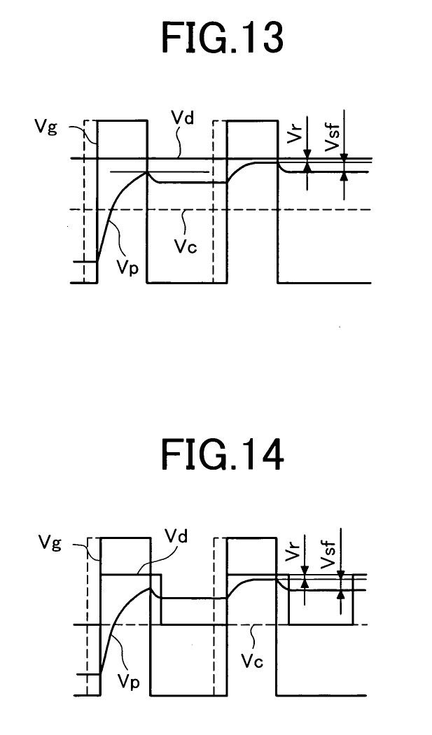

FIGS. 13 and 14 show driving methods in which t1 in FIG. 12B is eliminated. In the present embodiment, it is designed that the time the gate is opened is longer than the time the gate is closed. In the case of the gray display, as shown in FIG. 11B, there is no t1 during which the pixel potential Vp decreases. Thus, the gray display can be driven as described in the first embodiment. The present embodiment mainly deals with a case of the monochrome display that is significantly affected by the writing time in the staggered arrangement.

FIG. 13 shows a case in which the gray display is performed in the staggered arrangement, using the gate double pulse according to the present invention. In FIG. 13, the gate pulse corresponding to the first embodiment is indicated by dotted lines, and the present embodiment is indicated by solid lines. The gate pulse width in the present embodiment is less than the gate pulse width in the first embodiment. Incidentally, in the first embodiment, the gate pulse length is the same in both the ON and OFF states. In the present embodiment, the ON time is shorter than the OFF time. In the case of the gray display, the non-writing voltage is originally small and has no practical influence on the operation even if the gate pulse width is reduced.

FIG. 14 shows a case in which the monochrome display is performed in the staggered arrangement, using the gate double pulse according to the present invention. In FIG. 14, the signal writing is started at the same time when the scan line potential Vg of the second previous row is high level. When the pixel potential Vp increases to a certain value, the scan line potential of the second previous row is low level, and the gate of the TFT is turned OFF. At this time, the non-wiring voltage Vr1 is present. When the gate of the TFT is turned OFF, the pixel potential Vp is reduced by the V shift voltage Vsf and is maintained at this level. Then, when the scan line potential Vg of the current row is high level and the gate of the TFT is opened, the pixel potential Vp increases again. At this time, the pixel potential Vp has already increased because the initial value has been written in the second previous row, so that the pixel potential Vp sufficiently increases even if the writing time is short. As a result, the non-writing voltage Vr1 is very small.

In FIG. 14, the gate pulse of the first embodiment is indicated by dotted lines, and the gate pulse of the present embodiment is indicates by solid lines. The difference between the gate pulse rising edge indicated by the dotted line, and that indicated by the solid line, corresponds to t1 of FIG. 12B in the first embodiment. There is no t1 existing in the present embodiment, so that the pixel potential Vp does not decrease. As a result, the non-writing voltage Vr1 can be made much smaller than the case of the first embodiment. In the present embodiment, the time during which the scan line potential Vg is high level is different from the time during which the scan line voltage Vg is low level. Thus, it is necessary to have an IC for a scan circuit, which is different from the commonly used conventional IC. The cost for the new IC depends on the number of products.

What is claimed is:

1. A liquid crystal display device comprising pixels formed in a matrix shape, each surrounded by signal lines extending in a vertical direction and arranged in a horizontal direction as well as by scan lines extending in the horizontal direction and arranged in the vertical direction, in which an image signal is supplied from the signal lines to the pixels by selection of a scan line,
wherein, on one side of a specific signal line, a pixel corresponding to a specific color is connected to the specific signal line, and on the other side of the specific line, a pixel corresponding to a different color is connected to the specific signal line, and
a specific pixel is connected to a specific scan line, in which the image signal is supplied to the specific pixel when the specific scan line is selected and when a scan line that is two scans prior to the specific scan line is selected.

2. The liquid crystal display device according to claim 1,
wherein the polarities of the image signal supplied from the signal lines are opposite in adjacent lines.

3. The liquid crystal display device according to claim 1,
wherein the polarities of the image signal supplied from the signal lines are the same in one frame period, and are reversed when the frame is changed.

4. A liquid crystal display device comprising pixels formed in a matrix shape, each surrounded by signal lines extending in a vertical direction and arranged in a horizontal direction as well as by scan lines extending in the horizontal direction and arranged in the vertical direction,
wherein, on one side of a specific line, a pixel corresponding to a specific color is connected to the specific signal line, and on the other side of the specific signal line, a pixel corresponding to a different color is connected to the specific signal line,
the pixel includes a pixel electrode and a TFT, the TFT having a gate connected to the scan line, a source connected to the signal line, and a drain connected to the pixel electrode, in which a pixel signal is supplied from the signal line to the pixel when a gate pulse is supplied to the scan line, and
a TFT of a specific pixel is connected to a specific scan line, in which the image signal is supplied to the specific pixel when the gate pulse is supplied to the specific scan line and when the gate pulse is supplied to a scan line that is two scans prior to the specific scan line.

5. The liquid crystal display device according to claim 4,
wherein the gate pulse is supplied earlier than the start time of the image signal writing.

6. The liquid crystal display device according to claim 4,
wherein the gate pulse is supplied to a plurality of the scan lines in series at a predetermined period, the gate pulse having a width identical to the predetermined period.

7. The liquid crystal display device according to claim 4,
wherein the polarities of the image signal supplied from the signal lines are opposite in adjacent signal lines.

8. The liquid crystal display device according to claim 4,
wherein the polarities of the image signal supplied from the signal lines are the same in one frame period, and are reversed when the frame is changed.

9. A liquid crystal display device comprising pixels formed in a matrix shape, each surrounded by signal lines extending in a vertical direction and arranged in a horizontal direction as well as by scan lines extending in the horizontal direction and arranged in the vertical direction,
wherein, on one side of a specific signal line, a pixel corresponding to a specific color is connected to the specific signal line, and on the other side of the specific signal line, a pixel corresponding to a different color is connected to the specific signal line,
the pixel includes a pixel electrode and a TFT, the TFT having a gate connected to the scan line, a source connected to the signal line, and a drain connected to the pixel electrode, in which a pixel signal is supplied from the signal line to the pixel when a gate pulse is supplied to the scan line,
the gate pulse is supplied to a plurality of the scan lines in series at a predetermined period, the gate pulse having a width less than the predetermined period, and
a TFT of a specific pixel is connected to a specific scan line, in which the image signal is supplied to the specific pixel when the gate pulse is supplied to the specific scan line and when the gate pulse is supplied to a scan line that is two scans prior to the specific scan line.

10. The liquid crystal display device according to claim 9,
wherein the gate pulse is supplied at the same time when the image signal writing is started.

11. The liquid crystal display device according to claim 9,
wherein the polarities of the image signal supplied from the signal lines are opposite in adjacent signal lines.

12. The liquid crystal display device according to claim 9,
wherein the polarities of the image signal supplied from the signal lines are the same in one frame period, and are reversed when the frame is changed.
